(19) United States
(12) Patent Application Publication
(10) Pub. No.: US 2024/0211729 A1
(43) Pub. Date: Jun. 27, 2024

(54) Multiple Neural Network Training Nodes in a Read Channel

(71) Applicant: Western Digital Technologies, Inc., San Jose, CA (US)

(72) Inventors: Iouri Oboukhov, Rochester, MN (US); Richard Galbraith, Rochester, MN (US); Jonas Goode, Lake Forest, CA (US); Henry Yip, Bellflower, CA (US); Niranjay Ravindran, Rochester, MN (US)

(21) Appl. No.: 18/355,064

(22) Filed: Jul. 19, 2023

Related U.S. Application Data
(60) Provisional application No. 63/476,939, filed on Dec. 22, 2022.

(51) Int. Cl. G06N 3/045

(52) U.S. Cl. CPC G06N 3/045

(57) ABSTRACT

Example systems, read channels, and methods provide multiple neural network training nodes for processing read data signals prior to symbol detection and decoding. A plurality of neural network circuits receive read data signals and modify them based on different neural network configurations and sets of trained node coefficients. Each neural network circuit may pass modified read data signals directly to another neural network circuit or determine a parameter for modifying processing of the read data signals by another component. In some configurations, the last neural network circuit may pass the output read data signal to a soft output detector for determining the symbols in the read data signal.

### TECHNICAL FIELD

The present disclosure relates to data detection. In particular, the present disclosure relates to improved read channel data detection using machine learning.

### BACKGROUND

In present-day data transmission and storage mediums, such as disk, tape, optical, mechanical, and solid-state storage drives, data detection is based in large part on techniques developed in the early years of the data storage industry. While recently developed read channels invoke relatively new data encoding and detection schemes such as iterative detection and low-density parity codes (LDPC), much of the signal processing power in today's read channels is still based on partial-response maximum-likely-hood detection (PRML), developed in the early 1990's. Iterative LDPC code detectors use successive iterations and calculated reliability values to arrive at the most likely value for each bit. Soft information may be calculated for each bit and is sometimes represented by a log likelihood ratio (LLR) value, which is the natural logarithm of the ratio of the probability that the bit is a 1 divided by the probability that the bit is a 0. In some configurations a soft output Viterbi algorithm (SOVA) detector that determines LLR values for each bit may be paired with an iterative decoder for determining bias values for the next iteration of the SOVA. For example, a SOVA detector may be paired with an LDPC decoder that receives bit LLR values, returns extrinsic LLR values, and outputs hard decisions when LDPC constraints are met.

Data storage devices may incorporate multiple functional blocks for read signal processing prior to the read data arriving at the iterative detector (e.g., the paired SOVA detector and LDPC decoder). These functional blocks may preprocess the read signal, reduce noise, equalize state information, and/or otherwise modify the read signal and/or subsequent iterative detection. Use of a neural network for some or all of the read channel functions has been proposed.

There is a need for technology that efficiently improves error rate performance of read channels using neural networks in data transmission and/or storage devices.

### SUMMARY

Various aspects for data detection from a read signal using interconnected neural network circuits with different neural network training nodes to preprocess the read signal for a soft output detector are described.

One general aspect includes a read channel circuit that includes a first neural network circuit configured to: receive a first input read data signal corresponding to at least one data symbol; and modify, based on a first neural network configuration and a first set of trained node coefficients, the input read data signal to a first modified read data signal. The read channel circuit also includes a second neural network circuit configured to: receive a second input read data signal based on the first modified read data signal; determine, based on a second neural network configuration and a second set of node coefficients, an output read data signal corresponding to the at least one data symbol; and output the output read data signal to a soft output detector for determining the at least one data symbol.

Implementations may include one or more of the following features. The first neural network circuit may include a first training node configured to train the first set of trained node coefficients based on first node training logic; the second neural network circuit may include a second training node configured to train the second set of trained node coefficients based on second node training logic; and the first node training logic and the second node training logic may be different. The first node training logic may include: a first input read signal type; a first target output value type; a first loss function; a first training data source; and at least one first training condition. The second node training logic may include: a second input read signal type; a second target output value type; a second loss function; a second training data source; and at least one second training condition. The first node training logic may be different from the second node training logic based on at least one difference between at least one of: an input read signal type; a target output value type; a loss function; a training data source; and at least one training condition. The first node training logic may be configured to retrain the first set of trained node coefficients on a first time constant; the second node training logic may be configured to retrain the second set of trained node coefficients on a second time constant; and the first time constant may be different than the second time constant. The first node training logic may be configured to train the first set of node coefficients and the second node training logic may be configured to train the second set of node coefficients using at least one of: stored training data comprising a known sequence of data symbols; runtime training data based on a sequence of data symbols determined by the read channel circuit and a corresponding read data signal; and runtime training data based on at least one data symbol determined by hard decisions from the soft output detector and a corresponding read data signal. The first neural network circuit may be configured as a waveform combiner and further configured to: receive a third input read data signal; and combine the first input read data signal and the second input read data signal to modify the first input read data signal to the first modified read data signal. The second neural network circuit may be configured as a state detector; the output read data signal may include a vector of possible states for the at least one data symbol; and the soft output detector is configured to populate a decision matrix based on the vector of possible states for determining the at least one data symbol. The first neural network circuit may be configured as an equalizer and modifying the input read data signal to the first modified read data signal may include equalizing the input read data signal. The read channel circuit may include a third neural network circuit configured as a parameter estimator and configured to: receive a third input read data signal corresponding to the at least one data symbol; and determine, based on a third neural network configuration and a third set of trained node coefficients, an estimated parameter for modifying processing of the output read data signal. The read channel circuit may include adjustment logic configured to update, based on the estimated parameter, a corresponding operating parameter for the read channel circuit to modify processing of the output read data signal. The read channel circuit may include a plurality of intermediate neural network circuits, wherein each intermediate neural network circuit of the plurality of intermediate neural network circuits is configured to: receive at least one input read data signal corresponding to the at least one data symbol; and modify, based on a corresponding neural network configuration and a corresponding set of trained node coefficients, processing of the output read data signal. A data storage device may include the read channel circuit, a non-volatile storage medium, and an analog-to-digital converter configured to generate the first input read data signal based on data read from the non-volatile storage medium.

Another general aspect includes a method that includes: receiving, by a first neural network circuit, a first input read data signal corresponding to at least one data symbol; modifying, by the first neural network circuit and based on a first neural network configuration and a first set of trained node coefficients, the input read data signal to a first modified read data signal; receiving, by a second neural network circuit, a second input read data signal based on the first modified read data signal; determining, by the second neural network circuit and based on a second neural network configuration and a second set of node coefficients, an output read data signal corresponding to the at least one data symbol; and outputting, by the second neural network circuit, the output read data signal to a soft output detector for determining the at least one data symbol.

Implementations may include one or more of the following features. The method may include: training the first set of trained node coefficients based on first node training logic; and training the second set of trained node coefficients based on second node training logic, where the first node training logic and the second node training logic are different. The method may include retraining the first set of trained node coefficients on a first time constant; and retraining the second set of trained node coefficients on a second time constant, wherein the first time constant is different than the second time constant. Training the first set of node coefficients and training the second set of trained node coefficients use at least one of: stored training data may include a known sequence of data symbols; runtime training data based on a sequence of data symbols determined by a read channel circuit and a corresponding read data signal; and runtime training data based on at least one data symbol determined by hard decisions from the soft output detector and a corresponding read data signal. The method may include: receiving, by the first neural network circuit, a third input read data signal; and combining, by the first neural network circuit, the first input read data signal and the second input read data signal to modify the first input read data signal to the first modified read data signal. The method may include populating, by the soft output detector, a decision matrix based on a vector of possible states for the at least one data symbol, where the output read data signal from the second neural network circuit may include the vector of possible states for the at least one data symbol. Modifying, by the first neural network circuit, the input read data signal to the first modified read data signal may include equalizing the input read data signal. The method may include: receiving, by a third neural network circuit, a third input read data signal corresponding to the at least one data symbol; determining, by the third neural network circuit and based on a third neural network configuration and a third set of trained node coefficients, an estimated parameter for modifying processing of the output read data signal; and updating, based on the estimated parameter, a corresponding operating parameter to modify processing of the output read data signal.

Still another general aspect includes a data storage device that includes: a non-volatile storage medium; means for generating a first input read data signal based on data read from the non-volatile storage medium; a first means for receiving a first input read data signal corresponding to at least one data symbol and modifying, based on a first neural network configuration and a first set of trained node coefficients, the input read data signal to a first modified read data signal; and a second means for receiving a second input read data signal based on the first modified read data signal, determining, based on a second neural network configuration and a second set of node coefficients, an output read data signal corresponding to the at least one data symbol, and outputting the output read data signal to a soft output detector for determining the at least one data symbol.

The present disclosure describes various aspects of innovative technology capable of read channel data detection using a set of interconnected neural network circuits that can be separately trained to support various signal processing functions. The improved data detection provided by the technology may be applicable to a variety of computer systems, such as storage networks, storage systems, and/or signal transmission networks. The novel technology described herein includes a number of innovative technical features and advantages over prior solutions, including, but not limited to: (1) improved data detection in a storage device, (2) more efficient runtime retraining of individual neural network circuits for faster adaptation, (3) greater stability through compensation by different neural network circuits, and (5) flexibility to be adapted to data detection and analysis in a variety of different fields.

### BRIEF DESCRIPTION OF THE DRAWINGS

The techniques introduced herein are illustrated by way of example, and not by way of limitation, in the figures of the accompanying drawings in which like reference numerals are used to refer to similar elements.

FIG. 1A is a block diagram of a prior art disk format comprising a plurality of servo tracks defined by servo sectors.

FIG. 1B is a block diagram of a prior art solid state drive format comprising a plurality of dies each comprising a plurality of pages.

FIG. 2 is a block diagram of an existing storage system including various data processing components.

FIG. 3 is a block diagram of storage devices electronics using interconnected neural network circuits for processing a read signal.

FIGS. 4A, 4B, and 4C are block diagrams of example interconnected neural network circuits.

FIG. 5 is a diagram of example neural network configurations.

FIG. 6 is a table of example node training configurations for neural network circuits having different read signal processing functions.

FIG. 7 is an example method of processing a read signal using interconnected neural network circuits.

FIGS. 8A, 8B, 8C, and 8D are example methods of processing read data by different neural network circuits.

FIG. 9 is an example method of configuring and training each neural network circuit.

### DETAILED DESCRIPTION

Artificial neural networks (ANN) may be embodied in circuits or blocks within a read channel to perform specified functions historically performed by conventional hardware and/or software. Channel hardware may have specific limits to fit power, processing time, and other constraints. The value of adaptive circuits, including those based on neural networks, may depend on how fast and adaptive they are to changes in input data signals. A large, complex ANN circuit may spend a large amount of time and resources on training to determine a current set of weight coefficients fixed for runtime processing of the read data. This may limit both the frequency and responsiveness of adaptation through retraining and be less effective in a read channel application.

This disclosure provides systems, methods, and read channel circuit configurations to reduce training time and allow multiple functional blocks to train and retrain as fast as possible during runtime operation. Each neural network circuit may be simplified in neural network topology, such as the number of nodes and layers, to reflect narrower functional requirements of each neural network. This reduced complexity may enable faster and more frequent training. Dynamic training of different functional blocks through separate training nodes and corresponding training logic may reduce the original (pretraining) time during device manufacture and/or configuration, as well as enable adaptation to actual runtime use as the driving training data resource for each block. Dynamic training of different functional blocks may also enable faster and more granular adaptation, as well as compensation across functional blocks for greater change tolerance and signal processing reliability. Structuring smaller, interconnected neural network circuits around different training nodes and corresponding training data feedback loops may optimize dynamic operation and modification of the read channel based on the actual data being processed by the read channel in the field.

Novel data processing technology, such as but not limited to systems, data storage devices, read channels, and methods for detecting, decoding, and/or recovering previously encoded data in a data channel, such as a data storage read channel or data transmission receiver using interconnected neural network circuits to process read data for detection and decoding by an iterative detector are disclosed. While this technology is described below in the context of a particular system architecture in various cases, it should be understood that the systems and methods can be applied to other architectures and organizations of hardware.

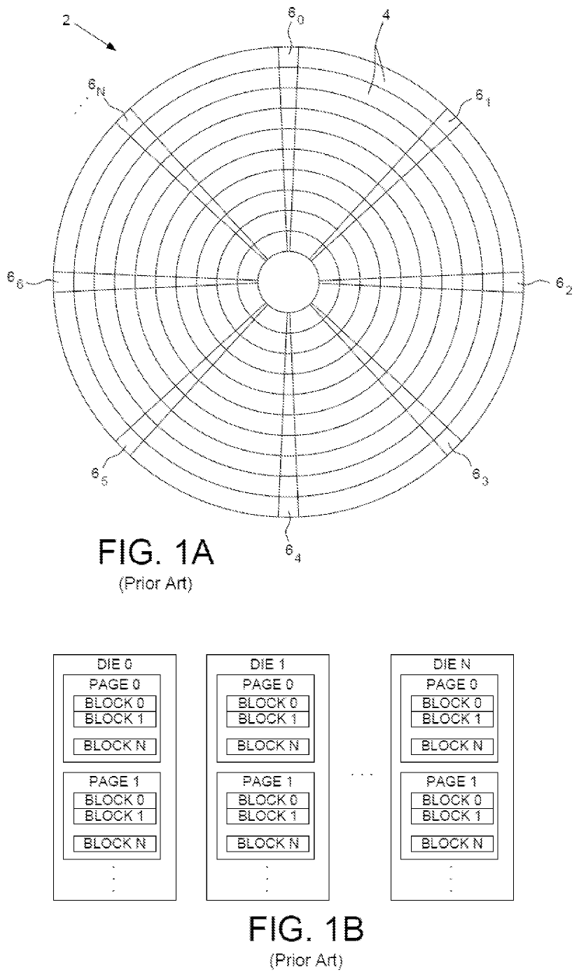

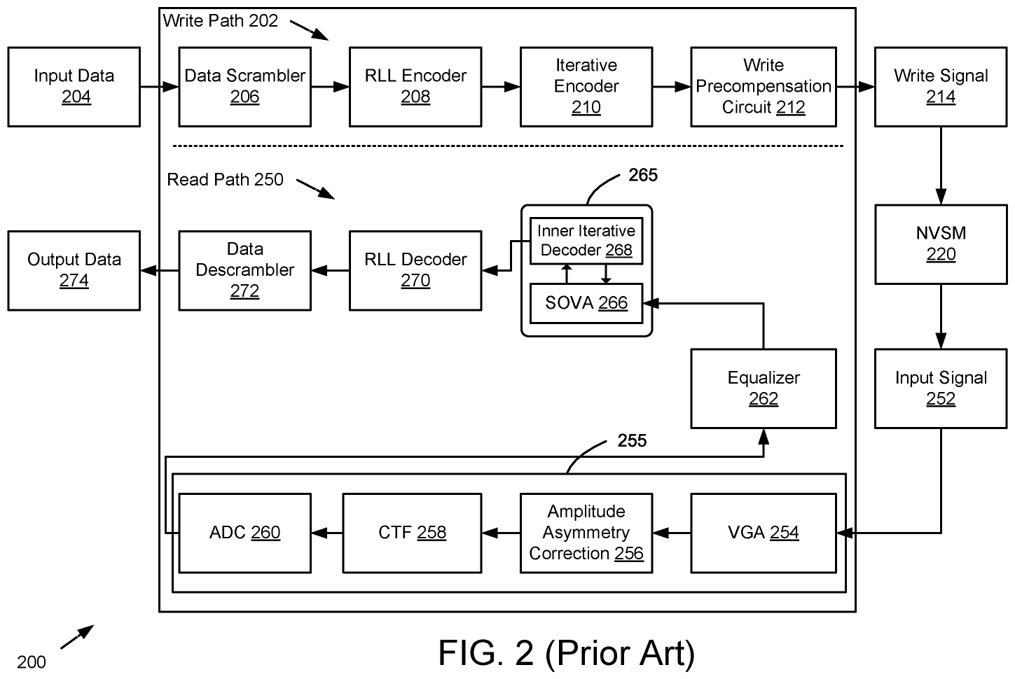

In some examples, the data channel technology may be applied to a data storage read channel for recovering encoded data from a non-volatile storage medium. For example, the read channel may be incorporated in a data storage device, such as a hard disk drive (HDD), a solid-state drive (SSD), a flash drive, an optical drive, a tape drive, etc. FIG. 1A shows a prior art disk format 2 as comprising a number of servo tracks 4 defined by servo sectors 6₀-6_{N} recorded around the circumference of each servo track. Data tracks are defined relative to the servo tracks at the same or different radial density, wherein each data track comprises a plurality of data sectors. Each data sector may store the data symbols of a single codeword, or in other examples, each data sector may store symbols from multiple codewords (i.e., interleaved codewords). FIG. 1B shows a prior art die format for a solid state drive, wherein each die may store multiple pages and each page may store multiple blocks each corresponding to a data sector or other data unit of encoded binary data of a disk drive.

In data storage devices incorporating non-volatile storage media, such as the disk of FIG. 1A or the non-volatile memory devices of FIG. 1B, an analog read signal from the storage media may be converted into a digital bit stream by an analog-to-digital-converter (ADC) and passed to the read channel for further processing. In some examples, bit data values may be stored to a non-volatile storage medium as data blocks or other data units using one or more encoding schemes. These bit data values may be processed from the digital bit stream in windows of multiple adjacent bits and a set of adjacent bits, such as 2, 3, 5, 7, or more continuous bits from the bit stream, may be processed as a symbol for data detection and/or decoding purposes. One or more symbols may, in turn, make up one or more codewords, such as codewords selected and encoded in accordance with an error detection and/or correction scheme, such as low-density parity check (LDPC) codes. These encoded codewords may be decoded to determine decoded bit values. In some examples, the decoded bit values from these codewords may still be subject to further decoding, such as run-length limited (RLL) decoding and/or descrambling to arrive that the output data. While the description below refers to non-volatile storage medium/media (NVSM) examples, the various examples disclosed could be applied to process data read from volatile medium/media as well, as well as data signals transmitted through and/or received from a wired, wireless, or other transmission medium.

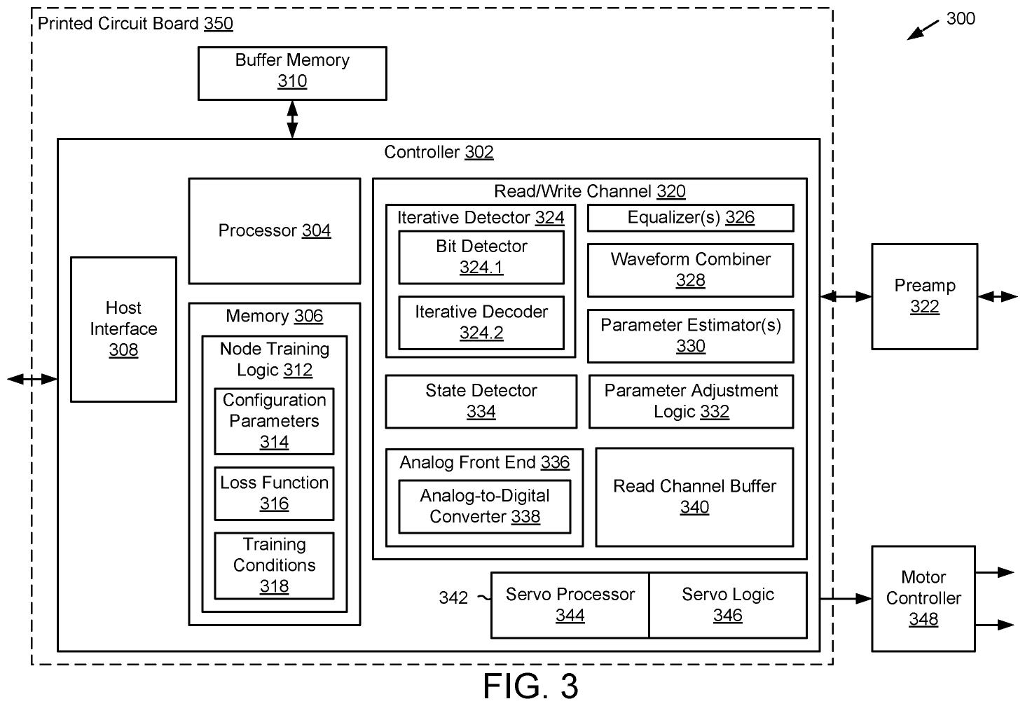

Referring to FIG. 2, a block diagram illustrating a configuration 200 comprising components employed in a known read/write path of a storage system. As illustrated, the write path 202 includes a data scrambler 206, an RLL encoder 208, an iterative encoder 210, and a write precompensation circuit 212. A write signal 214 may be output by the write path in some examples to store the resulting write bit stream to NVSM 220. Similarly, an input signal 252 may be read from NVSM 220 for processing through a read path 250. Read path 250 includes a variable gain amplifier (VGA), 254, an amplitude asymmetry correction (AAC) component 256, a continuous time filter (CTF) 258, an ADC 260, an equalizer 262, a soft output Viterbi algorithm (SOVA) 266, an inner iterative decoder 268, a RLL decoder 270, and a data descrambler 272. These component(s) receive input signals 252 as an analog read signal, and process, decode, and output the signals as output data 274, which may include decoded binary data units, such as data blocks. In some examples, these component(s) of read path 250 may comprise a read channel device or circuit.

The data scrambler 206 “randomizes” input data 204 (“whitens” the input sequence of the data) to be written into a storage media. In general, a storage system has no control over the data the user is going to write. This causes problems because it violates the assumptions that are usually made when designing storage systems, such as having independent data symbols. Since the data are not random, a frequently occurring problem is long strings of zeros in the data, which can cause difficulties in later timing recovery and adaptive equalization. These problematic sequences can be removed (or, actually, made much less likely) by introducing randomization of the input sequence for the input data 204. Therefore, during the data writing process, input data 204 may be first randomized by the data scrambler 206.

The RLL encoder 208 modulates the length of stretches in the randomized data. The RLL encoder 208 employs a line coding technique that processes arbitrary data with bandwidth limits. Specifically, the RLL encoder 208 can bound the length of stretches of repeated bits so that the stretches are not too long or too short. By modulating the data, the RLL encoder 208 can reduce the timing uncertainty in later decoding the stored data which would lead to the possible erroneous insertion of bits when reading the data back, and thus ensure the boundaries between bits can always be accurately found.

The iterative encoder 210 can append one or more parity bits to the modulated block code for later detection whether certain errors occur during data reading process. For instance, an additional binary bit (a parity bit) may be added to a string of binary bits that are moved together to ensure that the total number of “1”s in the string is even or odd. The parity bits may thus exist in two different types, an even parity in which a parity bit value is set to make the total number of “1”s in the string of bits (including the parity bit) to be an even number, and an odd parity in which a parity bit is set to make the total number of “1”s in the string of bits (including the parity bit) to be an odd number. In some examples, iterative encoder 210 may implement a linear error correcting code, such as LDPC codes or other turbo codes, to generate codewords that may be written to and more reliably recovered from NVSM 220. In some examples, iterative encoder 210 may further implement one or more single parity check codes within the codeword for recovery using soft information decoding, such as SOVA, Bahl, Cocke, Jelinek, Raviv (BCJR), or other single parity check code decoding techniques. The iterative encoder 210 may implement iterative encoding techniques to reuse the decoder architecture, thereby reducing circuit space.

The write precompensation circuit 212 can alleviate the effect of nonlinearities in the writing process. Major causes of the nonlinearities during data writing include bandwidth limitations in the write path and the demagnetizing fields in the magnetic medium for magnetic disks. These nonlinearities can cause data pattern-dependent displacements of recorded transitions relative to their nominal positions. The write precompensation circuit 212 can compensate for these data pattern-dependent displacements by introducing data pattern-dependent compensating shifts into the signals. After compensation, the information may then be written as NRZ (non-return to zero) data.

In an HDD embodiment, when reading data back from the NVSM 220, the data head of a storage drive senses the transitions (changes) in the storage medium and converts the information back into an electronic waveform. Reading analog input signal 252 from a storage medium starts at the storage medium (e.g., the drive's storage platter) and head transducer (not shown). The head transducer is located prior to the preamplifier circuit in the data read path and the head transducer output is driven by the data pattern previously written on a rotating disk. After converting into an electronic waveform, the head transducer output (e.g., input signal 252) may be further processed by the components illustrated in FIG. 2 in the read path 250 for data detection, decoding, and descrambling.

The VGA 254 amplifies the analog signal read back from the storage medium. The VGA 254 controls a signal level of the read-back analog signal based on a gain determined by an automatic gain control loop. One main function of the automatic gain control loop is to control an input signal level for optimum performance in the ADC 260. Too much gain from the VGA 254 can cause sample values in the ADC 260 to rail at maximum or minimum ADC levels, while too little gain can cause quantization noise to dominate the signal-to-noise ratio (SNR) and thus adversely affect bit error rate performance.

The AAC 256 and the CTF 258 work to linearize the amplified analog signal prior to feeding it to the ADC 260. In an HDD embodiment, the AAC 256 works to reconstruct linearity that may have been lost in the head transducer stage when the information on the storage disk is converted into an electronic signal at the output of the data head. The biasing of the head signal may in some cases be adjusted to keep the signal in the linear range of the head sensitivity curve. However, if the signal amplitude changes due to fly height or disk variation exceed the head transducer linear range, saturation in the peak or trough of the electrical head signal can occur. The AAC 256 may use signal offset to determine the amount of squared signal to add back to restore the positive and negative symmetry of the signal.

It should be noted that in practice, the read back analog signals from many different commonly used heads in existing devices cannot be linearized, regardless of the kind of biasing approach that is employed. Thus, improving data detection and recovery technology in the read channel can advantageously handle the read back signals from these types of heads because it may better compensate for non-linear responses from the read heads.

The CTF 258 provides mid-band peaking to help attenuate high-frequency noise and minimize any aliasing that may occur when the analog signal is converted to a sampled representation. In an HDD embodiment, aliasing may not have a large effect on a drive surface's bit error rate performance. However, it can have an impact on disk drive manufacturing yields. The CTF 258 is typically a multiple pole low pass filter (e.g., a four pole Butterworth filter) with a zero available for mid-band peaking. Signal peaking can be used to emphasize frequency components, which are useful in shaping the signal to meet the digital target signal characteristic. Besides anti-aliasing, the CTF 258 may also partially equalize the data.

The ADC 260 can convert an analog signal (e.g., input signal 252), as input and/or processed by upstream components) to digital samples quantized in time and amplitude. The clock used may include the output of a digital phase-locked loop, which tracks the channel rate clock frequency. The output of the ADC may be used as feedback to control the timing of the digital phase-locked loop as well as the automatic gain control, DC baseline correction, and equalization. The VGA 254, the CTF 258, and the ADC 260, with or without the AAC 256, together may be called an analog front end 255, as the signals processed in these components are analog, while the signals in the remaining downstream components of the read path may be digital, although other variations of an analog front end 255 (which may be considered as one example form of an analog to digital convertor) may comprise software and/or hardware elements configured to convert signals from analog to digital and/or include other components for filtering, tuning, and/or processing data. In an HDD embodiment, the read channel analog front-end functions are generally similar regardless of whether the data is recorded using perpendicular or horizontal techniques.

The equalizer 262 is used for compensating for channel distortion. For example, an FIR filter may perform filtering to provide additional equalization of the signal to match signal characteristic to the desired target response for bit detection. Some equalizers may also include a noise whitening filter that further equalizes the spectrum of the signal from the FIR samples to remove noise that has non-flat amplitude spectrum. For example, the noise whitening filter may enhance low-level spectral components and attenuates high-level ones. At the output of the equalizer 262, the signal is now in a fully digital form and ready for detection of the encoded bits. The sample stream is submitted to the sequence detector (e.g., the iterative decoder 265) to begin decoding in trellises for bit recovery.

The SOVA 266 may use a Viterbi-like algorithm to decode a bit stream for bit recovery. The SOVA 266 may include a variant of the classical Viterbi algorithm. It may differ from the classical Viterbi algorithm in that it uses a modified path metric which takes into account a priori probabilities of the input symbols, and produces a soft output indicating the reliability of the decision. The SOVA 266 operates by constructing a trellis of state of probabilities and branch metrics. In some examples, SOVA 266 may be configured to detect the probabilities of bit values based on single parity check codes. Once the bit recovery is completed, parity post-processing can be performed. In some examples, an initial set bit probabilities may be provided to inner iterative decoder 268 for parity-based decoding of the codeword, initiating iterative bit detection by SOVA 266 and parity determination by inner iterative decoder 268 with the two components exchanging sets of bit probabilities as extrinsic information for reaching their maximum likelihood results and returning a decoding decision.

The inner iterative decoder 268 may help to ensure that the states at the parity block boundary satisfy the parity constraint by conducting parity error checking to determine whether data has been lost or written over during data read/write processes. It may check the parity bits appended by the iterative encoder 210 during the data writing process, and compare them with the bits recovered by the SOVA 266. Based on the setting of the iterative encoder 210 in the data writing process, each string of recovered bits may be checked to see if the “1”s total to an even or odd number for the even parity or odd parity, respectively. A parity-based post processor may also be employed to correct a specified number of the most likely error events at the output of the Viterbi-like detectors by exploiting the parity information in the coming sequence. The SOVA 266 and the inner iterative decoder 268 together may be referred to as an iterative decoder 265, as iterative decoding may exist between the two components. For example, SOVA 266 may pass detected sets of bit probabilities to inner iterative decoder 268 and inner iterative decoder 268 may use those bit probabilities to determine a most likely codeword match. If decode decision parameters are not met, inner iterative decoder 268 may feedback soft information for the set of bit probabilities to SOVA 266 as extrinsic information for further iterations of the SOVA bit detector and SOVA 266 may feed forward a new set of bit probabilities for each iteration to inner iterative decoder 268. When decode decision parameters are met, the codeword may be decoded into a set of decoded bit values for output or further processing by RLL decoder 270 and data descrambler 272.

The RLL decoder 270 may decode the run length limited codes encoded by the RLL encoder 208 during the data writing process, and the data descrambler 272 may descramble the resulting sequence, which eventually can reveal the original user data written into the storage media. The recovered or read data, output data 274, may then be sent to a requesting device, such as a host computer, network node, etc., in response to receiving the request for the data.

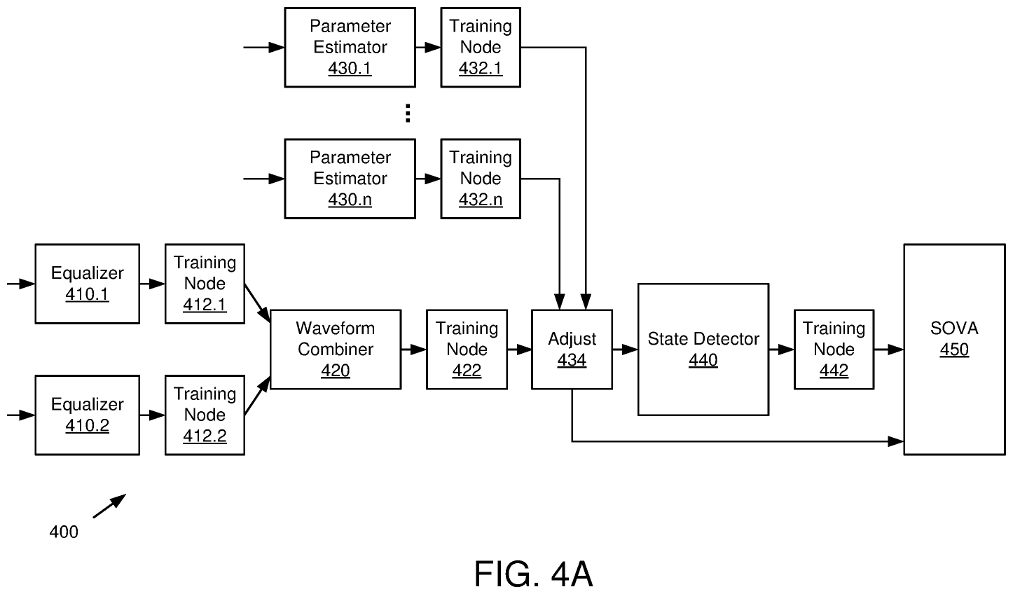

FIG. 3 shows a portion of example control circuitry 300 for a data storage device, such as a hard disk drive. In the example shown, control circuitry 300 may include one or more controllers. Controller 302 may comprise a storage device controller configured to receive host storage commands, process storage operations for writing, reading, and managing data stored to non-volatile storage media in the disk drive, such as the magnetic media disks in FIGS. 1 and 2. In some embodiments, controller 302 may correspond to a separate host interface and read/write path to a subset of disk surfaces in a data storage device with multiple controllers. In some embodiments, controller 302 may be configured to manage servo and read/write operations for one or more actuators, heads, and corresponding writer and reader elements.

Controller 302 may comprise a processor 304, a memory 306, a host interface 308, and access to a buffer memory 310. Controller 302 may also comprise a read/write channel 320, and a servo controller 342 including a servo processor 344 and servo logic 346. In some embodiments, one or more of host interface 308, read/write channel 320, and servo controller 342 may be embodied in separate packages, such as application specific integrated circuits (ASICs), systems on a chip (SOCs), or other specialized circuits that interface with processor 304 and memory 306 for carrying out their respective functions. Controller 302 may include physical and electrical interfaces for connecting to buffer memory 310, a power source (not shown), preamp 322, motor controller 348, other controllers, and/or other circuitry components. In some embodiments, the components of controller 302 may be interconnected by a bus that includes one or more conductors that permit communication among the components. For example, processor 304, memory 306, host interface 308, read/write channel 320, and/or servo controller 342 may be components attached to a printed circuit board assembly (PCBA) 350 that provides one or more layers of interconnect conductors among the components. In some configurations, controller 302 may be embodied in one or more integrated circuits comprising and/or interfacing with a plurality of other circuits or electronic components for executing various functions based on hardware logic and/or software running on one or more processor components.

Processor 304 may include any type of conventional processor or microprocessor that interprets and executes instructions. Memory 306 may include a random access memory (RAM) or another type of dynamic storage device that stores information and instructions for execution by processor 304 and/or a read only memory (ROM) or another type of static storage device that stores static information and instructions for use by processor 304 and/or any suitable storage element, such as a system portion of a hard disk media or a solid state storage element. Memory 306 may be configured to store controller firmware, comprising instructions that include one or more modules or sub-modules for specific data storage device operations and processor 304 may execute those instructions, including controlling communication with other components, such as host interface 308, buffer memory 310, read/write channel 320, and servo controller 342. In some configurations, one or more features of host interface 308, buffer memory 310, read/write channel 320, and/or servo controller 342 may be embodied in firmware stored in memory 306 for execution by processor 304. In some configurations, memory 306 may be used to store one or more modules for execution during the manufacture, configuration, and/or runtime operation of the storage device. For example, node training logic 312 may be used to train the neural networks for various functional read signal processing circuits in read channel 320 during storage device manufacturing and/or during normal operation of the device.

Host interface 308 may include any transceiver-like mechanism that enables the data storage device to communicate with other devices and/or systems, such as a host system for which the storage device provides data storage. Host interface 308 may comprise a host storage interface compliant with one or more storage interface standards, such as a Serial Advanced Technology Attachment (SATA) interface, a Small Computer System Interface (SCSI), serial attached SCSI (SAS), peripheral computer interface express (PCIe) (e.g., Non-Volatile Memory Express (NVMe)), etc., for connecting host interface 308 to peripheral interface or network port.

Buffer memory 310 may include a RAM, flash, or another type of dynamic storage device for storing host data and other information in transit between the storage media of the storage device and the host (via host interface 308). In some embodiments, buffer memory 310 is a separate memory device from memory 306 and the disk surfaces or other non-volatile memory of the data storage device.

Read/write channel 320 may include one or more specialized circuits configured for processing binary data to be written to the disk surfaces using an analog write signal and processing the analog read signal from the disk surfaces back into binary data. For example, read/write channel 320 may include a write path or write channel comprised of various data scramblers, run-length limited (RLL) encoders, iterative error correction code (ECC) encoders, precompensation circuits, and other data or signal processing components. Read/write channel 320 may include a read path or read channel comprised of various amplifiers, filters, equalizers, analog-to-digital converters (ADCs), soft information detectors, iterative ECC decoders, and other data or signal processing components. The write channel components may comprise a write channel circuit and the read channel components may comprise a read channel circuit, though the circuits may share some components. Read/write channel 320 may provide the analog write signal to and receive the analog read signal from preamp 322, which controls and amplifies signals to and from the heads. Binary data for recording to the storage medium may be received by read/write channel 320 from controller firmware and decoded data from read/write channel 320 may be passed to controller firmware and/or directed to buffer memory 310 for communication to the host.

In some configurations, read/write channel 320 may include an analog front end 336 configured to receive the analog read signal from preamp 322 and convert it into a digital read signal for processing by other components of read/write channel 320. For example, analog front end 336 may include an ADC 338 that receives an analog data signal from preamp 322 and generates a digital signal for use by other components of read/write channel 320. ADC 338 may sample the analog read signal at a predefined channel baud rate to determine digital signal values corresponding to a digital read signal waveform.

In some configurations, read channel 320 may include at least one read channel buffer memory 340 configured to temporarily store the digital read signal data generated by the ADC before it passed to other components, such as an equalization circuit in the read path to iterative detector 324. For example, read channel buffer 340 may include a set of volatile memory locations for buffering a portion of the digital read signal, such as a number of baud rate samples corresponding to a data sector or a portion thereof. Read channel buffer 340 may hold digital read signal data before or concurrent with moving it into iterative detector 324 along the read path. In some configurations, other processes or modules may use the data from read channel buffer 340. For example, during training or retraining of neural network circuits, the digital signal data may be used as training data and node training logic 312 may compare the output from the training data to known signal values based on a known stored data pattern or the symbol value determinations of bit detector 324.1 or iterative detector 324. In some configurations, one or more neural network circuits may sample digital read signal data from an initial portion of a data sector prior to that data sector being processed by iterative detector 324. For example, parameter estimators 330 may be configured to sample an initial portion of each data sector for determining noise correction, delta SNR, position, or other parameters used to adjust signal processing, detection, and decoding in read channel 320.

In some configurations, read write channel 320 may include an iterative detector 324 configured to receive read data from the read heads and use iterative bit detection and ECC processing to decode the received read data into decoded data for further processing by controller firmware and/or communication to the host. For example, iterative detector 324 may include one or more bit detectors 324.1, such as soft output Viterbi algorithm (SOVA) detectors, and one or more iterative decoders 324.2, such as low density parity check (LDPC) decoders operating on multi-bit encoded symbols to decode each sector of data received by read/write channel 320. Iterative detector 324 may receive a digital read signal from ADC 338 in analog front end 336 through one or more signal processing neural network circuits. In some configurations, iterative detector 324 may include one or more parameters for compensating for one or more types of noise and other parameter changes in the digital read signal. For example, iterative detector 324 may include noise canceling parameters for jitter, electronic noise, and/or color noise to modify the input waveform signal values to bit detector 324.1.

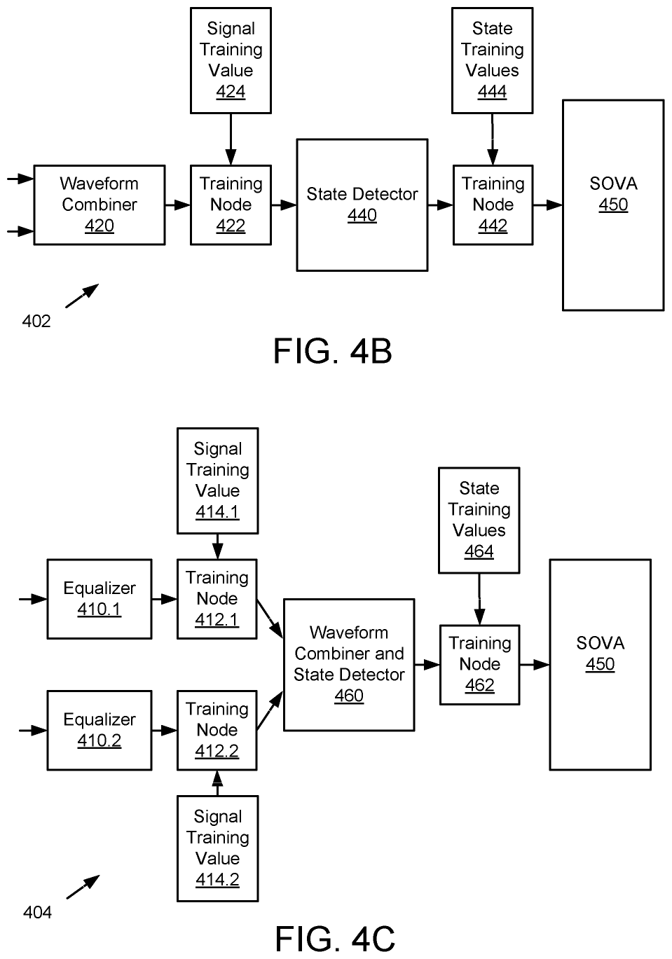

In some configurations, read/write channel 320 may include a set of logic features embodied in circuits, blocks, or processing nodes for processing the digital read signal values from analog-to-digital converter 338 prior to detection and decoding by iterative detector 324. For example, read/write channel 320 may include equalizers 326, waveform combiner 328, parameter estimators 330 (and corresponding parameter adjustment logic 332), and state detector 334. In some configurations, each circuit may comprise a trained neural network configured for one or more signal processing functions. In some configurations, two or more signal processing functions may be combined in a single neural network circuit. Different example configurations of the neural network circuits are further described with regard to FIGS. 4A-4C below.

Equalizers 326 may include one or more neural network equalizer circuits configured to receive unequalized read data signals from ADC 338, compensate for channel distortion, and output equalized read data signals for further processing. For example, a deep neural network inference engine trained to the desired target response for bit detection may be trained to function similar to a finite impulse response (FIR) filter. In some configurations, equalizers 326 may also be trained for noise whitening that further equalizes the spectrum of the signal to remove noise that has non-flat amplitude spectrum. For example, the target response used to train equalizers 326 may enhance low-level spectral components and attenuate high-level ones. In some configurations, equalizers 326 may each include an input node configured to receive the input read data signal corresponding to a single read element, a plurality of hidden layers with a specific neural network node configuration and corresponding trained node coefficients that weight the signal filtering, and an output node for the equalized read data signal. The output node may be selectively coupled to a training node for the equalizer circuit. In some configurations, the equalizer training node may be used to configure the node coefficients during a training or retraining process by comparing the equalized read data signal with a known data pattern using a defined loss function to iteratively adjust the node coefficient values. In some configurations, a read head may include multiple read elements and a separate equalizer circuit may be configured to receive and equalize each read head read data signal.

Waveform combiner 328 may include a neural network signal combiner circuit to receive multiple read data signals for the same stored data and combine the multiple read data signals into a single read data signal. For example, a deep neural network inference engine may be trained to align two or more read data signals and combine signal amplitudes to generate a combined read data signal. In some configurations, waveform combiner 328 include a number of input nodes equal to the number of incoming read signals (e.g., two), a plurality of hidden layers with a specific neural network node configuration and corresponding trained node coefficients that weight the signal combination, and an output node for the combined read data signal. In some configurations, waveform combiner 328 may receive input read data signals from equalizers 326 and combine the equalized read data signals into a combined equalized read data signal. The output node may be selectively coupled to a training node for the waveform combiner circuit. In some configurations, the wave combiner training node may be used to configure the node coefficients during a training or retraining process by comparing the combined read data signal with a known data pattern using a defined loss function to iteratively adjust the node coefficient values. In some configurations, waveform combiner 328 may output the combined read data signal to state detector 334. In some configurations, the functions of waveform combiner 328 may be combined with state detector 334 in a single neural network circuit.

Parameter estimators 330 may include one or more neural network estimator circuits that receive a read data signal and determine at least one parameter from the read data signal. For example, a deep neural network inference engine may be configured with node coefficients trained for separating and quantifying a noise component, a change in SNR, position, or other read signal parameters. In some configurations, multiple parameter estimators 330 may each be trained for estimating a different read signal parameter that can be fed forward for adjusting one or more operating parameters of the read channel. For example, one or more estimator circuits may be configured for separating the noise component of the read signal and quantifying the relative mixture of noise types. The resulting output set of estimate values may include a jitter value, an electronic noise value, and one or more color noise values that may be used to adjust corresponding noise compensation values in state detector 334 and/or iterative detector 324. In some configurations, parameter estimators 330 may include an input node configured to receive a read data signal in parallel with the read data signal being processed through equalizers 326, waveform combiner 328, state detector 334, and/or iterative detector 324 (i.e., the primary read data path). For example, parameter estimators 330 may read buffered data from ADC 338 stored in read channel buffer 340. Parameter estimators 330 may include a plurality of hidden layers with a specific neural network node configuration and corresponding trained node coefficients that weight the parameter estimation and an output node for one or more parameter estimate values. The output node may be selectively coupled to a training node for the estimator circuit. In some configurations, the estimator training node may be used to configure the node coefficients during a training or retraining process by comparing the estimated parameter values to known parameter values and/or variance from a known data pattern using a defined loss function to iteratively adjust the node coefficient values.

Unlike other components that act directly on the read data signal as it passed through the primary read signal data path, parameter estimators 330 may be configured to modify other operating parameters used by read channel components, such as iterative detector 324 and/or state detector 334. Read/write channel 320 may include parameter adjustment logic 332 configured to determine how updated parameter estimates from parameter estimators 330 are used to adjust or modify the operation of the read channel. In some configurations, parameter adjustment logic 332 may include logic for converting a set of estimate values from a trained parameter estimator to one or more operating parameters for adjusting the read channel to compensate for changes in the estimated parameter, such as a noise value or noise mixture, SNR change, position, etc. For example, parameter adjustment logic 332 may map each noise type estimate and/or the relationships among the noise type estimates to corresponding adjustment values for noise correction to the read signal wave form before it is processed by iterative detector 324. In some embodiments, each noise type may correspond to a different signal noise filter to be applied to the digital read signal and the noise estimate values may each be mapped to one or more tap value parameters for the different signal noise filters. For example, parameter adjustment logic 332 may include a lookup table or transfer function for determining tap value settings from the set of estimate values. In some configurations, the digital read signal may have the parameter adjustments applied prior to being received by bit detector 324.1, such as a SOVA detector, and/or through state detector 334. For example, the read path may pass the digital read signal data through a set of noise filters to adjust the wave form prior to the state detection by state detector 334 and/or iterative processing by bit detector 324.1 to determine bit value likelihoods.

State detector 334 may include a neural network state detector circuit that receives a read data signal and determines a set of state values for each possible state of a symbol that can be passed to iterative detector 324. For example, a deep neural network inference engine may be trained to determine a vector of state values for each sequential symbol in the input read data signal, where 1 represents a correct state and 0 indicates an incorrect state. In some configurations, the state values may be used to populate the initial decision matrix of iterative detector 324, such as the Viterbi matrix of a soft output detector (e.g., bit detector 324.1). In some configurations, state detector 334 includes a number of input nodes equal to the number of incoming read signals (e.g., one for an equalized and combined read data signal, two or more if the state detector function is combined with the wave combiner functions), a plurality of hidden layers with a specific neural network node configuration and corresponding trained node coefficients that weight the state value determinations, and a set of output nodes corresponding to each possible state value (e.g., each state value in the vector of state values). The output node may be selectively coupled to a training node for the state detector circuit. In some configurations, the state detector training node may be used to configure the node coefficients during a training or retraining process by comparing the output state values with the state values for a known data pattern using a defined loss function to iteratively adjust the node coefficient values.

In some configurations, memory 306 may include node training logic 312 for training the node coefficients of neural network circuits, such as equalizers 326, waveform combiner 328, parameter estimators 330, and state detector 334. For example, node training logic 312 may include functions, parameters, data structures, and interfaces used during manufacturing or configuration of the data storage device to selectively access the respective training nodes and initiate separate training loops for each neural network based on one or more sets of stored training data with known data patterns. In some configurations, node training logic 312 may be configured for runtime retraining of the node coefficients to allow the neural networks to dynamically adjust during operation of the data storage device. In addition to lifetime variations in signal quality, channel characteristics, noise sources, etc., dynamic adjustment of the neural network circuits may enable compensation for variations across disks, heads, data sectors, etc. and how they interact with various data patterns, track squeeze, position errors, fly height, defects, etc. In some configurations, node training logic 312 may selectively interface with the training nodes of each neural network circuit to initiate and/or manage each training (or retraining) process.

Node training logic 312 may be configured to use one or more training data sources for retraining (note that retraining refers to node coefficient training after the initial training of node coefficients and training and retraining may be used interchangeably when describing runtime retraining). For example, the storage medium may be configured with a training data pattern of known bits/symbols (in a reserved location) that may be used for retraining purposes throughout the life of the data storage device. In other configurations, runtime data may be used for training data based on the bit/symbol determinations made by the read channel. For example, after a data unit, such as a data sector, is successfully decoded by iterative detector 324, the data pattern for that data unit is known and the data storage device may still retain the source read data signal in read channel buffer 340. Node training logic 312 may be configured to have one or more neural network circuits retrain by reprocessing the previously processed read data signal and using the fully decoded data pattern determined by the read channel for the known or ideal data signal for the training loss function. In other configurations, a shorter time constant may be desired (compared to full data unit/sector decode time) and intermediate bit/symbol decisions may be used for retraining even though they have not been validated by the full decode process. For example, hard decisions from bit detector 324.1 may be used as the known data pattern for feedback to the training nodes during runtime retraining.

In some configurations, node training logic 312 may include a set of configuration parameters 314 for each neural network circuit. Configuration parameters 314 may define the input(s), output(s), and neural network configuration (nodes, layers, topology, functions, etc.) for each neural network circuit. In some configurations, configuration parameters 314 may also indicate connections to other neural network circuits in the read channel, such as a source neural network circuit (or other component) for an input read data signal and a destination neural network circuit (or other component) for the output values. In some configurations, configuration parameters 314 may include the training data source and loss function 316 for training the neural network circuit. Training data source may include one or more of the training data sources described above for runtime retraining and loss function 316 may specify the comparisons used between known and determined values for retraining node coefficients. In some configurations, node training logic 312 may also include a set of training conditions for each neural network circuit. For example, each neural network circuit may have a time constant defined based on the type of runtime training data used and how frequently the neural network circuit should be adjusted (e.g., every symbol, every sector, every track, etc.). In some configurations, training conditions 318 may define other trigger conditions, such as error rate thresholds, operating periods, events (e.g., startup, power cycling, first read since unload, etc.), etc. for triggering retraining through one or more training nodes.

Servo controller 342 may include one or more specialized circuits configured to process servo data, such as position error signals, from the disk surfaces and providing a control signal to position the actuators in a closed-loop control system. Servo controller 342 may also receive commands from processor 304 for positioning operations, such as seek, track follow, load, unload, sweep, idle, and other actuator positioning operations. Servo controller 342 may also implement servo error recovery processes for recovering from servo errors. In some embodiments, servo controller 342 may include servo processor 344 and servo logic 346 (stored in a servo memory). For example, servo processor 344 may be a dedicated processor circuit and servo logic 346 may be firmware stored in RAM associated with the dedicated processor to provide dedicated computing resources for managing the servo functions. Servo controller 342 may receive servo signals read from the disk surface using preamp 322 and provided to servo controller 342. Servo controller 342 may provide servo control signals to motor controller 348 and motor controller 348 may control one or more actuator voice coil motors (VCMs) and/or a spindle motor for rotating the disk stack.

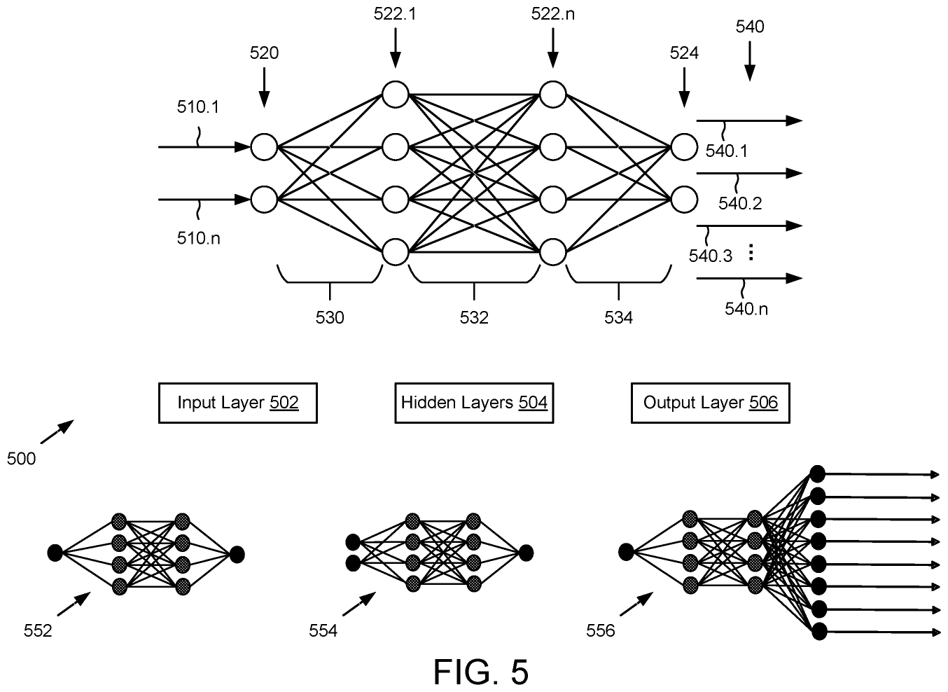

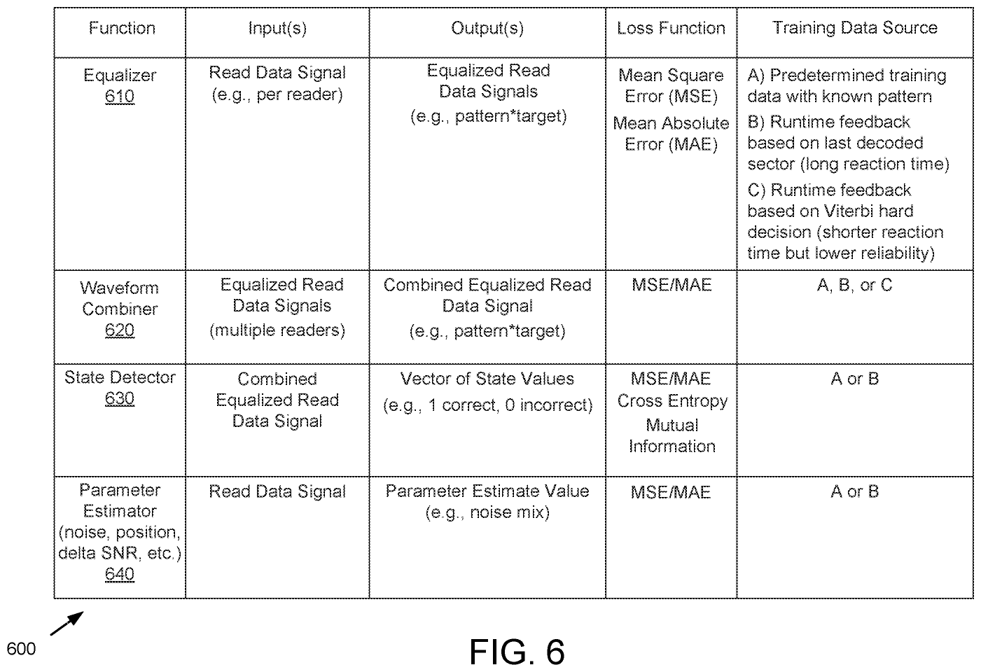

FIG. 4A shows a first example configuration 400 of signal processing functions embodied in interconnected neural network circuits in the read channel between an ADC (not shown) and SOVA 450. For example, configuration 400 includes two equalizers 410.1 and 410.2 for a two read element reader, inline waveform combiner 420, two or more parameter estimators 430.1-430.n for adjusting operating parameters of the read channel, and state detector 440 for determining initial state values for SOVA 450. Additional details of the individual neural network circuits, their neural network configurations, and training logic is provided below with regard to FIGS. 5 and 6.

Equalizers 410.1 and 410.2 may receive digital read signals from the ADC (or ADCs) and equalize them based on their current set of node coefficients. Equalizers 410.1 and 410.2 are separate neural networks and each paired with a respective equalizer training node 412.1 and 412.2. As described elsewhere, equalizer training nodes 412.1 and 412.2 may selectively be invoked according to node training logic for the neural networks to train or retrain the node coefficients of the neural networks.

Waveform combiner 420 may receive the equalized read data signals from equalizer circuits 410.1 and 410.2 and combine them based on its current set of node coefficients. Waveform combiner 420 may be paired with a waveform combiner training node 422 for being trained using a separate training loop from equalizers 410.1 and 410.2, parameter estimators 430.1-n, state detector 440, and/or other interconnected neural networks. As described elsewhere, waveform combiner training node 422 may selectively be invoked according to node training logic for the neural network to train or retrain the node coefficients of the neural network.

Parameter estimators 430.1-n may receive read data signals from the ADC separate from the primary read path, such as from a buffer memory that receives the digital samples for the read data signal, and determine one or more read signal parameters from the read data signal. Each parameter estimator 430.1-n may be paired with a corresponding estimator training node 432.1-n for being trained using a separate training loop to the other parameter estimators (and other interconnected neural networks). As described elsewhere, estimator training nodes 432.1-n may selectively be invoked according to node training logic for the neural networks to train or retrain the node coefficients of that neural network. In some configurations, parameter estimators 430 may not operate directly on the read data signal to SOVA 450, but the output value may be used to adjust or modify an operating parameter of the read channel (thus impacting the detection and decoding of the read data signal). For example, parameter estimators 430 may provide one or more estimated parameter values to parameter adjustment logic 434 and parameter adjustment logic 434 may modify the read data signal based on the estimated parameter values. In some configurations, one or more operating parameters may be adjusted for the read data signal going to state detector 440. In some configurations, one or more operating parameters may be adjusted for SOVA 450.

State detector 440 may receive read data signals that have been processed and/or modified by each of the preceding neural network circuits and determine a set of state values for each symbol in the input read data signal. State detector 440 may be paired with a corresponding state detector training node 442 for being trained using a separate training loop to the preceding neural networks. As described elsewhere, state detector training node 442 may selectively be invoked according to node training logic for the neural network to train or retrain the node coefficients. The output vector from state detector 440 may be passed to SOVA 450 and used to populate its decision matrix.

FIG. 4B shows another example configuration 402 of signal processing functions embodied in interconnected neural network circuits in the read channel between an ADC (not shown) and SOVA 450. Configuration 402 does not include equalizers. In some configurations, waveform combiner 420 may be configured to equalize and combine read data signals directly from the ADC or buffer memory. Waveform combiner 420 has a corresponding waveform combiner training node 422 that receives signal training value 424 during training or retraining, such as a known pattern based on short time constant or longer time constant processing by the iterative detector. The output of waveform combiner 420 may be fed to state detector 440 to determine state values for SOVA 450. State detector 440 may include a separate state detector training node 442 that receives a state training value 444. In some configurations, signal training value 424 and state training value 444 may have different sources and different time constants to allow waveform combiner 420 and state detector 440 to independently retrain their respective node coefficients over time.

FIG. 4C shows another example configuration 404 of signal processing functions embodied in interconnected neural network circuits in the read channel between the ADC (not shown) and SOVA 450. Configuration 404 uses a combined waveform combiner and state detector 460. In some configurations, equalizers 410.1 and 410.2 receive separate read data signals from the ADC (or ADCs) and equalize them based on distinct sets of node coefficients. Equalizers 410.1 and 410.2 may have corresponding equalizer training nodes 412.1 and 412.2 that receive corresponding signal training values 414.1 and 414.2 during training or retraining. The output equalized read data signals may be fed to waveform combiner and state detector 460 to determine state values for SOVA 450. Combined combiner/detector 460 may include two input nodes, similar to waveform combiner 420 and a set of output nodes corresponding to the state values in the vector sent to SOVA 450. The neural network configuration (number of layers, topology, etc.) may be configured and trained to both combine the read data signals and determine values for the possible states in a single neural network circuit. Combiner/detector 460 may include a combiner/detector training node 462 that receives state training values 464. In some configurations, state training values 464, signal training value 414.1, and signal training value 414.2 may have different sources and different time constants to allow equalizer 410.1, equalizer 410.2, and combiner/detector 460 to independently retrain their respective node coefficients.

FIG. 5 shows an example neural network 500 for signal processing neural network circuits, such as equalizers 410, waveform combiner 420, parameter estimators 430, state detector 440, and/or combiner/detector 460. Neural network 500 may include a number of nodes and connections organized in layers. For example, neural network 500 may include an input layer 502, hidden layers 504, and output layer 506. Diagrams 552, 554, and 556 show other example neural network configurations with different node topologies. Many other variations are possible. Input layer 502 may include one or more nodes 520 configured to receive inputs 510.1-510.n. In the example shown, input layer 502 may include two input nodes 520 configured to each receive an input 510 from the digital read signal. For example, the digital read signal may include a pair of read signals from dual read heads that read the data on the storage medium in parallel. Input 510.1 may be the digital read signal sample from the first read head and input 510.n may be the digital read signal sample from the second head. In some configurations, inputs 510 may include sets of digital samples of a predefined sample size from the digital read signal waveform. For example, unequalized data samples from the read channel ADC may be received as inputs from a buffer memory. In other configurations, a single input node for a single read element or a previously combined read signal may be used, as shown in diagrams 552 and 556.

Neural network 500 may be configured with any number of hidden layers 504. In the example shown, hidden layers 504 include two node layers 522.1 and 522.n and each node layer comprises four nodes. Any number of node layers may be used and more or fewer nodes may be present in each layer, depending on the desired topology of the neural network. In some configurations, each neural network circuit may use a single-layer topology to minimize complexity and training time for each training loop. Each node layer 522 may be interconnected by a set of connections, such as connections 532. Similarly, connections 530 may connect nodes 522.1 to input nodes 520 and connections 534 may connect nodes 522.n to output nodes 524. Each node may include a non-linear transfer function and a weighting or node coefficient. In some configurations, weighting coefficients may be separately applied and trained for each connection between node layers.

Neural network 500 may include multiple output nodes 524 configured to output the inference values generated by neural network 500. In the example shown, neural network 500 included two output nodes 524 outputting output values 540. In some configurations, output values may correlate to modified input values such that an input read data signal is modified to a modified read data signal, both with the same nominal baud rates and synchronization. For example, input read data signals may be modified by equalization, combination, or other filtering. Diagram 554 shows an example waveform combiner topology that receives two input read data signals and combines them into a combined read data signal. As shown in neural network 500, the number of output nodes (e.g., two) does not necessarily determine the number of output values, depending on the nature of the transfer functions used. In some configurations, the number of outputs may be mapped to individual output nodes. For example, a state detector may use a topology similar to diagram 556 and map each 3-bit symbol in the input read data signal to state values for the eight possible states of a 3-bit symbol. Therefore, depending on the configuration of the neural network, any number of output values may be determined from one or more read data streams with a variety of different neural network topologies.

FIG. 6 shows a table describing four example neural network circuit types that may be used for processing read data signals. Each neural network circuit is configured for a specific read data signal processing function, receives a defined input read data signal and generates defined output data. Each function may be trained using one or more loss functions and one or more training data sources.

In some configurations, equalizer 610 may be a neural network circuit configured to receive an unequalized read data signal, such as the read data signal generated by the ADC, as an input read data signal. If there are multiple readers for the same data, multiple equalizers may be used with each corresponding to a reader. Equalizer 610 may output equalized read data signals based on pattern*target training. Equalizer 610 may be trained using mean square error (MSE) or mean absolute error (MAE) as the loss function. Equalizer 610 may be trained using any of the example data sources: A) predetermined training data with a known pattern (e.g., a known data pattern stored to the storage medium); B) runtime feedback based on the last decoded sector (e.g., read channel output following a successful decode of a data unit); or C) runtime feedback based on Viterbi hard decision (e.g., hard decision on pattern values made by a soft output detector such as a Viterbi decision matrix without the benefit of LDPC, global iterations, or full decode).

In some configurations, waveform combiner 620 may be a neural network circuit configured to receive equalized read data signals from multiple readers (and conventional or neural network equalizers) as input read data signals. Waveform combiner 620 may output a combined equalized read data signal based on pattern*target training. Waveform combiner 620 may be trained using MSE or MAE as the loss function. Waveform combiner 620 may be trained using any of the example data sources, A, B, or C.

In some configurations, state detector 630 may be a neural network circuit configured to receive combined equalized read data signals, such as from equalizer 610 and waveform combiner 620, as input read data signals. State detector 630 may output a vector of state values for the read data signal based on training correct states to 1 and incorrect states to 0. In addition to MSE or MAE, state detector 630 may use cross entropy or mutual information in the loss function. State detector 630 may be trained using example training data A or B.

In some configurations, parameter estimator 640 may be a neural network circuit configured to receive a read data signal, which may include the read data signal generated by the ADC or any other read data signal (equalized, combined, etc.) as appropriate to the parameter, as input read data signals. Read signal parameters, such as noise, position, delta SNR, etc., that may be mapped to adjusting one or more operating parameters of the read channel may be the basis for different parameter estimators. Parameter estimator 640 may output one or more parameter estimate values, such as noise mix. Parameter estimator 640 may be trained using MSE or MAE as the loss function. Parameter estimator 640 may be trained using example data sources A or B.

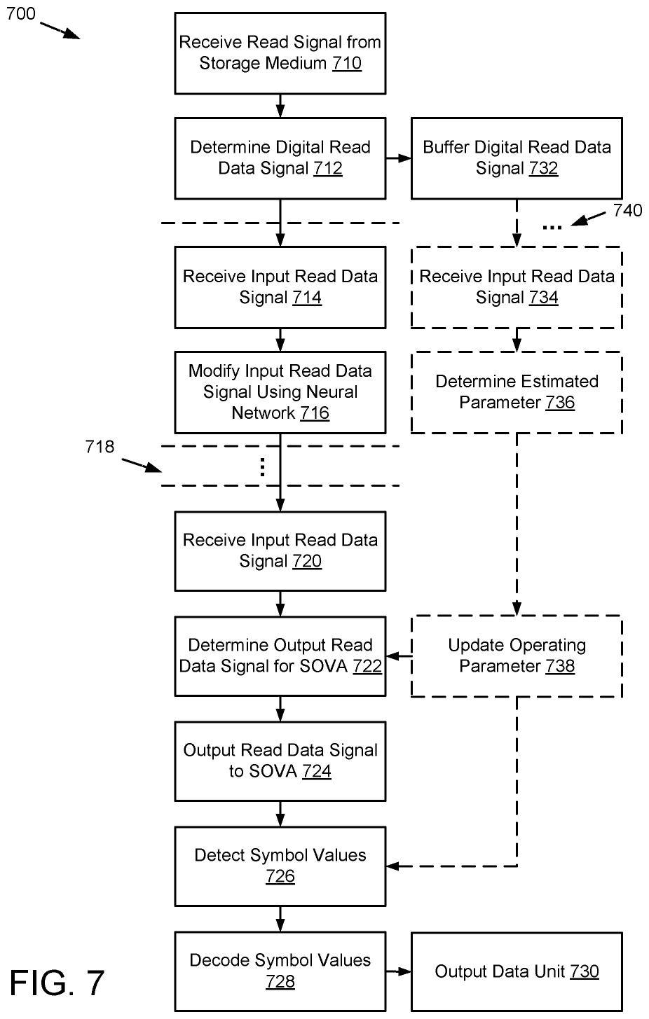

As shown in FIG. 7, control circuitry 300 may be operated according to an example method of processing a read signal using interconnected neural network circuits, i.e., according to the method 700 illustrated by blocks 710-738. As described above, different configurations (e.g., FIGS. 4A, 4B, and 4C) of sequential neural networks and/or parallel neural networks may be used to process a read data signal for detecting and decoding data symbols in the read data signal.

At block 710, a read signal may be received from a storage medium. For example, an analog read signal may be generated from magnetic disk or tape media and/or from solid state memory, based on corresponding read electronics.

At block 712, a digital read data signal may be determined. For example, the analog read signal from block 710 may be processed by an ADC to determine digital sample values corresponding to the analog read signal.

At block 714, an input read data signal may be received by a first neural network circuit. For example, an equalizer, waveform combiner, or other data processing circuit may receive the digital read data signal from the ADC.

At block 716, the input read data signal may be modified using a neural network. For example, the neural network circuit receiving the input read data signal at block 714 may process the signal through its neural network configuration using its current set of node coefficients to output a modified read data signal based on its function (e.g., equalization, combination, other filtering or conditioning, etc.).

At 718, blocks 714 and 716 may be repeated for any number of additional sequential neural network circuits. Each intermediate neural network circuit may receive the modified read data signal output by the prior neural network circuit as the input read data signal for its processing and may output a corresponding modified read data signal to a next neural network circuit in the sequence. For example, an equalizer may pass the read data signal to a signal combiner, the signal combiner may pass the read data signal to a noise filter, and so on until the read data signal (modified by each preceding neural network circuit) is passed to a final neural network circuit in the sequence at block 720.

At block 720, an input read data signal may be received by a last neural network circuit in the sequence. For example, a state detector may receive the modified read data signal from the prior component, such as waveform combiner or filter.

At block 722, an output read data signal for the soft output detector (e.g., SOVA) may be determined. For example, the state detector may determine a vector of state values for each symbol in the read data signal.

At block 724, the read data signal may be output to the soft output detector. For example, the state detector may send the vectors of state values to the SOVA to populate the decision matrix for bit detection.

At block 726, symbol values may be detected. For example, the SOVA may make bit determinations for the data symbols in the read data signal, which may include soft information passed to an iterative decoder and/or hard decisions passed to other components (such as fed back for neural network retraining).

At block 728, symbol values may be decoded. For example, the soft information may be received by an LDPC decoder for iterative decoding of the symbol values according to their ECC encoding to determine final values for the symbols and the data unit of which they are a part.

At block 730, a decoded data unit may be output. For example, the read channel may output the successfully decoded data unit to controller firmware for the data storage device to return the data to a host system. In some configurations, the successfully decoded data unit may provide a known data pattern for feeding back to one or more neural network circuits for retraining.

In some configurations, the digital read data signal may be buffered or stored at block 732. The buffered read data signal data may be processed outside the primary read data path described at blocks 710-730 to support other neural network circuits that determine other parameters in parallel with the primary read data path. Blocks 734-738 show an example parallel processing path that may change the operating parameters of the primary read data path through the read channel. As shown at 740, any number of these parallel neural network circuits may be included in method 700.

At block 734, an input read data signal is received. For example, the neural network circuit, such as a parameter estimator, may read the read data signal from a buffer memory.

At block 736, an estimated parameter may be determined. For example, the neural network circuit may process the input read data signal through its neural network configuration and using its current set of node coefficients to determine an estimated parameter value based on the input read data signal.

At block 738, an operating parameter may by updated based on the estimated parameter. For example, parameter adjustment logic may use a change in the estimated parameter to determine an update to one or more operating parameters of the read channel to change operation of the primary read path, such as an operating parameter of the state detector or iterative detector.

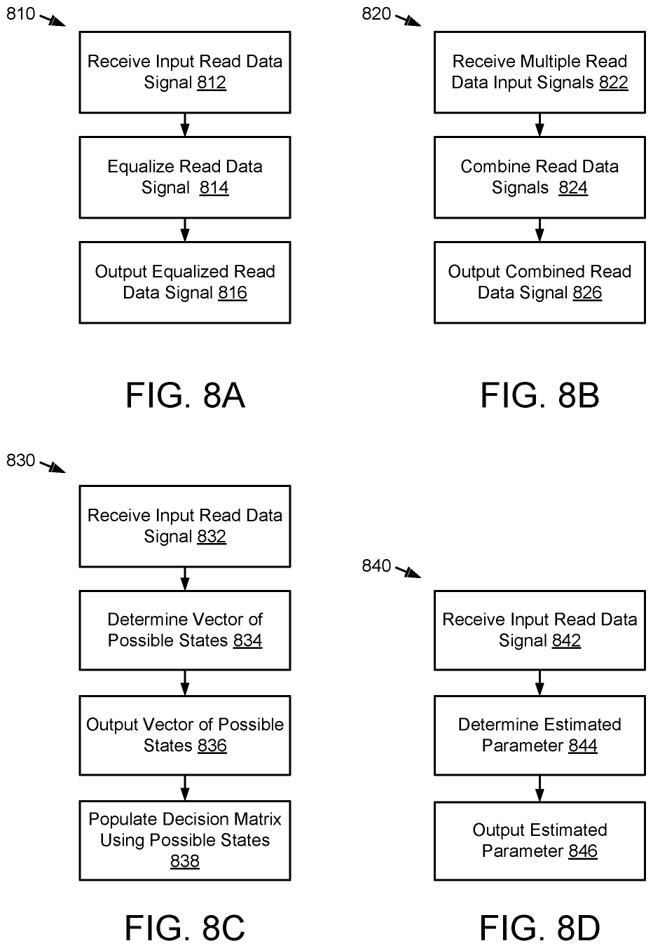

As shown in FIGS. 8A, 8B, 8C, and 8D, control circuitry 300 may be operated according to example methods of processing a read signal using example neural network circuits, i.e., according to the methods 810, 820, 830, and/or 840 illustrated by blocks 812-816, 822-826, 832-838, and/or 842-846. In some configurations, one or more of methods 810, 820, 830, and 840 may be used to modify the read data signal in method 700 of FIG. 7.

In FIG. 8A, method 810 may be executed by an equalizer neural network circuit. At block 812, a read data input signal may be received. For example, the equalizer may receive an unequalized read data signal from an ADC or another component. At block 814, the read data signal may be equalized. For example, the equalizer may process and modify the read data signal through its neural network configuration based on its current set of node coefficients to equalize the read data signal. At block 816, an equalized read data signal may be output. For example, the equalizer may send the equalized read data signal to a next neural network circuit along a read path.

In FIG. 8B, method 820 may be executed by a waveform combiner neural network circuit. At block 822, multiple read data input signals may be received. For example, the waveform combiner may receive two read data signal from ADCs, equalizers, or other components. At block 824, the read data signals may be combined. For example, the waveform combiner may process and modify the read data signals through its neural network configuration based on its current set of node coefficients to combine the read data signals. At block 816, a combined read data signal may be output. For example, the waveform combiner may send the combined read data signal to a next neural network circuit along a read path.

In FIG. 8C, method 830 may be executed by a state detector neural network circuit. At block 832, a read data input signal may be received. For example, the state detector may receive a read data signal from an ADC, equalizer, waveform combiner, or another component. At block 834, a vector of possible states may be determined for the read data signal. For example, the state detector may process and modify the read data signal through its neural network configuration based on its current set of node coefficients to determine a vector of possible states for each sequential symbol in the read data signal. At block 836, the vectors of possible states for the read data signal may be output. For example, the state detector may send the possible states read data signal to a next component along a read path, such as a soft output detector. At block 838, a decision matrix may be populated using the possible states. For example, the states detector may send the vector of possible states into the Viterbi matrix of the soft output detector to populate it.

In FIG. 8D, method 840 may be executed by a parameter estimator neural network circuit. At block 842, a read data input signal may be received. For example, the parameter estimator may receive a read data signal from an ADC or a buffer memory storing at least a portion of the read data signal. At block 844, an estimated parameter may be determined from the read data signal may. For example, the parameter estimator may process and modify the read data signal through its neural network configuration based on its current set of node coefficients to generate one or more estimated parameters. At block 846, the estimated parameter may be output. For example, the parameter estimator may send the estimated parameter to parameter adjustment logic for the read channel to modify the operating parameters of another neural network circuit or other component, such as the iterative detector, along the primary read path.

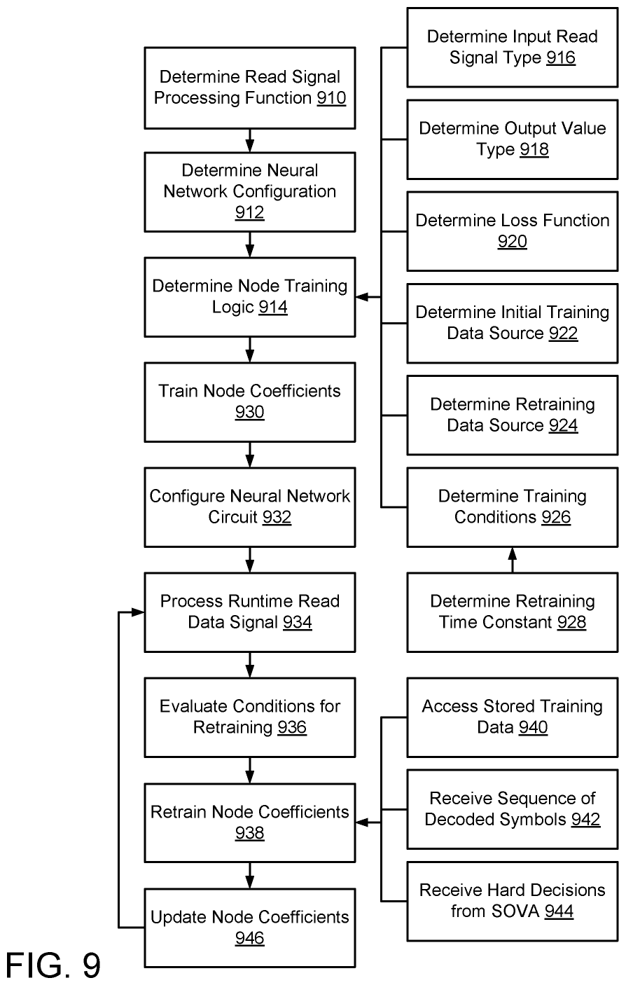

As shown in FIG. 9, control circuitry 300 may be operated according to an example method of configuring and training each neural network circuit, i.e., according to the method 900 illustrated by blocks 910-948. In some examples, method 900 may be executed separately by node training logic 312 for each neural network circuit in control circuitry 300.

At block 910, a read signal processing function may be determined. For example, a read channel may be configured with a plurality of neural networks performing different signal processing functions, such as equalization, combination, filtering, state detection, etc., and a specific function may be selected for the neural network being configured.

At block 912, a neural network configuration may be determined. For example, a neural network topology (e.g., see FIG. 5) and transfer functions may be configured for the neural network circuit.

At block 914, node training logic may be determined. For example, a set of training parameters may be defined for the neural network circuit. Example training parameters are described with regard to blocks 916-928. At block 916, an input read signal type may be determined. For example, the input source of the neural network circuit may be a read data signal and may or may not include prior equalization, combination, or other filtering or conditioning. At block 918, an output value type may be determined. For example, the output destination for the neural network circuit may be configured to receive a read data signal or parameter of a particular type, such as a read data signal (equalized, combined, etc.) or a parameter type (noise, position, delta SNR, etc.). At block 920, a loss function may be determined for adjusting node coefficients based on differences between a determined value and target value for the neural network circuit output. For example, loss functions may be selected from MSE, MAE, cross entropy, and mutual information loss functions. At block 922, an initial training source may be determined. For example, during manufacture or configuration, the neural network circuit may be trained based on known data read from the storage medium or otherwise provided to the read channel to set initial node coefficients for the neural network to use at runtime. At block 924, a retraining data source may be determined. For example, the neural network may be retrained based on stored data or runtime data that has a known data pattern. At block 926, training conditions may be determined. For example, retraining may be initiated at different times for different neural network circuits and may include different timing, threshold, and/or event-based conditions for triggering. In some configurations, at block 928, a retraining time constant may be determined to reflect whether the neural network can be retrained using a relatively short time constant (less time between data read and retraining) or longer time constants (more time between data read and retraining). For example, short time constant retraining may include using hard decision data from the soft output detector for feedback prior to full decode and long time constant retraining may include using fully decoded symbol/bit decisions.

At block 930, the node coefficients may be trained. For example, during manufacture, configuration, or initialization of a data storage device, node training logic may train the node coefficients for their initial values.

At block 932, the neural network circuit may be configured and deployed. For example, the node training logic may set the node coefficients to their initial values determined at block 930 for runtime processing of read data in subsequent read operations.

At block 934, runtime read data signals may be processed. For example, the neural network circuit may be deployed in the read channel and operate to process read data signals as they are received from the storage medium.

At block 936, conditions for retraining may be evaluated. For example, the node training logic and/or the configuration of the neural network circuit and corresponding training node may determine the conditions under which retraining of the node coefficients occurs.

At block 938, node coefficients may be retrained. For example, node coefficients may be periodically retrained at runtime based on the availability of training data and/or other conditions. Examples of training data sources for runtime retraining are shown in blocks 940-946. At block 940, stored training data may be accessed. For example, the node training logic may access training data stored on the storage medium for retraining during idle periods or when necessitated by error thresholds. At block 942, a sequence of decoded symbols may be received. For example, following the successful decode of a data unit, such as a data sector, the known data pattern may be fed back to the training node for use in training the node coefficients from the corresponding read data signal. At block 944, hard bit/symbol decisions may be received from the bit detector, such as the SOVA. For example, the soft output detector probabilities may be used to determine the most likely bit values (hard decision) and fed back to the training node for a shorter training time constant (in spite of the reduced accuracy of the known pattern).

At block 946, the node coefficients are updated based on the retraining. For example, the updated node coefficients from block 938 may be stored in the neural network circuit for the next read data signal processing and operation may return to block 934.

Technology for improved read channel data detection using multiple neural networks is described above. In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to particular hardware.

Reference in the specification to “one embodiment” or “an embodiment” means that a particular feature, structure, or characteristic described in connection with the embodiment is included in at least one embodiment or implementation of the disclosed technologies. The appearances of the phrase “in one embodiment” in various places in the specification are not necessarily all referring to the same embodiment or implementation.

Some portions of the detailed descriptions above may be presented in terms of processes and symbolic representations of operations on data bits within a computer memory. A process can generally be considered a self-consistent sequence of operations leading to a result. The operations may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), erasable programmable read-only memories (EPROMs), electrically erasable programmable read-only memories (EEPROMs), magnetic or optical cards, flash memories including universal serial bus (USB) keys with non-volatile memory or any type of media suitable for storing electronic instructions, each coupled to a computer system bus.

The disclosed technologies can take the form of an entire hardware implementation, an entire software implementation or an implementation containing both hardware and software elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The terms storage media, storage device, and data blocks are used interchangeably throughout the present disclosure to refer to the physical media upon which the data is stored.

Finally, the processes and displays presented herein may not be inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A read channel circuit, comprising:
a first neural network circuit configured to:
receive a first input read data signal corresponding to at least one data symbol; and
modify, based on a first neural network configuration and a first set of trained node coefficients, the input read data signal to a first modified read data signal;
a second neural network circuit configured to:
receive a second input read data signal based on the first modified read data signal;
determine, based on a second neural network configuration and a second set of node coefficients, an output read data signal corresponding to the at least one data symbol; and
output the output read data signal to a soft output detector for determining the at least one data symbol.

2. The read channel circuit of claim 1, wherein:
the first neural network circuit comprises a first training node configured to train the first set of trained node coefficients based on first node training logic;
the second neural network circuit comprises a second training node configured to train the second set of trained node coefficients based on second node training logic; and
the first node training logic and the second node training logic are different.

3. The read channel circuit of claim 2, wherein:
the first node training logic comprises:
a first input read signal type;
a first target output value type;
a first loss function;
a first training data source; and
at least one first training condition;
the second node training logic comprises:
a second input read signal type;
a second target output value type;
a second loss function;
a second training data source; and
at least one second training condition; and
the first node training logic is different from the second node training logic based on at least one difference between at least one of:
an input read signal type;
a target output value type;
a loss function;
a training data source; and
at least one training condition.

4. The read channel circuit of claim 2, wherein:
the first node training logic is configured to retrain the first set of trained node coefficients on a first time constant;
the second node training logic is configured to retrain the second set of trained node coefficients on a second time constant; and
the first time constant is different than the second time constant.

5. The read channel circuit of claim 2, wherein the first node training logic is configured to train the first set of node coefficients and the second node training logic is configured to train the second set of node coefficients using at least one of:
stored training data comprising a known sequence of data symbols;
runtime training data based on a sequence of data symbols determined by the read channel circuit and a corresponding read data signal; and
runtime training data based on at least one data symbol determined by hard decisions from the soft output detector and a corresponding read data signal.

6. The read channel circuit of claim 1, wherein the first neural network circuit is configured as a waveform combiner and further configured to:
receive a third input read data signal; and
combine the first input read data signal and the second input read data signal to modify the first input read data signal to the first modified read data signal.

7. The read channel circuit of claim 1, wherein:
the second neural network circuit is configured as a state detector;
the output read data signal comprises a vector of possible states for the at least one data symbol; and
the soft output detector is configured to populate a decision matrix based on the vector of possible states for determining the at least one data symbol.

8. The read channel circuit of claim 1, wherein:
the first neural network circuit is configured as an equalizer; and
modifying the input read data signal to the first modified read data signal comprises equalizing the input read data signal.

9. The read channel circuit of claim 1, further comprising:
a third neural network circuit configured as a parameter estimator and configured to:
receive a third input read data signal corresponding to the at least one data symbol; and
determine, based on a third neural network configuration and a third set of trained node coefficients, an estimated parameter for modifying processing of the output read data signal; and
adjustment logic configured to update, based on the estimated parameter, a corresponding operating parameter for the read channel circuit to modify processing of the output read data signal.

10. The read channel circuit of claim 1, further comprising:
a plurality of intermediate neural network circuits, wherein each intermediate neural network circuit of the plurality of intermediate neural network circuits is configured to:
receive at least one input read data signal corresponding to the at least one data symbol; and
modify, based on a corresponding neural network configuration and a corresponding set of trained node coefficients, processing of the output read data signal.

11. A data storage device comprising the read channel circuit of claim 1, and further comprising:
a non-volatile storage medium; and
an analog-to-digital converter configured to generate the first input read data signal based on data read from the non-volatile storage medium.

12. A method comprising:
receiving, by a first neural network circuit, a first input read data signal corresponding to at least one data symbol;
modifying, by the first neural network circuit and based on a first neural network configuration and a first set of trained node coefficients, the input read data signal to a first modified read data signal;
receiving, by a second neural network circuit, a second input read data signal based on the first modified read data signal;
determining, by the second neural network circuit and based on a second neural network configuration and a second set of node coefficients, an output read data signal corresponding to the at least one data symbol; and
outputting, by the second neural network circuit, the output read data signal to a soft output detector for determining the at least one data symbol.

13. The method of claim 12, further comprising:
training the first set of trained node coefficients based on first node training logic; and
training the second set of trained node coefficients based on second node training logic, wherein the first node training logic and the second node training logic are different.

14. The method of claim 13, further comprising:
retraining the first set of trained node coefficients on a first time constant; and
retraining the second set of trained node coefficients on a second time constant, wherein the first time constant is different than the second time constant.

15. The method of claim 13, wherein training the first set of node coefficients and training the second set of trained node coefficients use at least one of:
stored training data comprising a known sequence of data symbols;
runtime training data based on a sequence of data symbols determined by a read channel circuit and a corresponding read data signal; and
runtime training data based on at least one data symbol determined by hard decisions from the soft output detector and a corresponding read data signal.

16. The method of claim 12, further comprising:
receiving, by the first neural network circuit, a third input read data signal; and
combining, by the first neural network circuit, the first input read data signal and the second input read data signal to modify the first input read data signal to the first modified read data signal.

17. The method of claim 12, further comprising:
populating, by the soft output detector, a decision matrix based on a vector of possible states for the at least one data symbol, wherein the output read data signal from the second neural network circuit comprises the vector of possible states for the at least one data symbol.

18. The method of claim 12, wherein modifying, by the first neural network circuit, the input read data signal to the first modified read data signal comprises equalizing the input read data signal.

19. The method of claim 12, further comprising:
receiving, by a third neural network circuit, a third input read data signal corresponding to the at least one data symbol;
determining, by the third neural network circuit and based on a third neural network configuration and a third set of trained node coefficients, an estimated parameter for modifying processing of the output read data signal; and
updating, based on the estimated parameter, a corresponding operating parameter to modify processing of the output read data signal.

20. A data storage device comprising:
a non-volatile storage medium;
means for generating a first input read data signal based on data read from the non-volatile storage medium;
a first means for:
receiving a first input read data signal corresponding to at least one data symbol; and
modifying, based on a first neural network configuration and a first set of trained node coefficients, the input read data signal to a first modified read data signal; and
a second means for:
receiving a second input read data signal based on the first modified read data signal;
determining, based on a second neural network configuration and a second set of node coefficients, an output read data signal corresponding to the at least one data symbol; and
outputting the output read data signal to a soft output detector for determining the at least one data symbol.
